(19) United States
(12) Patent Application Publication
(10) Pub. No.: US 2008/0235409 A1
(43) Pub. Date: Sep. 25, 2008

(54) Multiple Phase Buffer Enlargement for Rdma Data Transfer Related Applications

(76) Inventor: Alexey Vitalievich Ryzhykh, Sarov (RU)

Correspondence Address: Blakely sokoloff Taylor & Zafman, 12400 Wilshire Boulevard, 7th Floor, Los Angeles, CA, 90025, US

(21) Appl. No.: 10/587,533

(22) PCT Filed: May 31, 2006
(86) PCT No.: PCT/RU06/00288

§ 371 Date: Jul. 26, 2006

(51) Int. Cl. G06F 13/28

(52) U.S. Cl. 710/22

(57) ABSTRACT

Methods of provisioning remote direct memory access (RDMA) buffers are disclosed. In one aspect, a method may include determining that a pre-registered RDMA buffer has insufficient size to transfer a particular data. A larger RDMA buffer, which is larger than the pre-registered RDMA buffer, may then be provisioned. Then, the data may be transferred to a potentially remote node over a network using the provisioned larger RDMA buffer. Other methods, including methods of receiving data, are also disclosed. Apparatus and system to implement such methods are also disclosed.

### RELATED APPLICATIONS

### BACKGROUND

1. Field

Embodiments of the invention relate to data transfer techniques in electronic systems. In particular, embodiments of the invention relate to provisioning of buffers in remote direct memory access (RDMA).

2. Background Information

Remote Direct Memory Access (RDMA) is a well-known data transfer technique. RDMA may allow two or more potentially remote network interconnected computer systems or other network devices to utilize one anothers main memory via direct memory access. Since the direct memory access may proceed without substantial involvement of the host processors or operating systems, the data transfers may advantageously proceed in parallel with other system operations. Further background information on RDMA, if desired, is widely available in the public literature, such as, for example, in the reference InfiniBand Network Architecture, First Edition, pages 1-1131, by Tom Shanley, from MindShare, Inc.

RDMA conventionally tends to use large amounts of memory for buffers. In order to save time on buffer registration and deregistration for each RDMA data transfer operation, buffers, such as, for example, circular buffers, may be pre-allocated and pre-registered for each established connection. By way of example, one set of buffers may be pre-registered on the sending node and another corresponding set of buffers may be pre-registered on the receiving node. Data may be copied to a set of buffers on the sending side, and then an RDMA data transfer operation may transfer the data across a network to the corresponding set of buffers on the receiving side. The size of each of the buffers may be relatively large so that it may accommodate correspondingly sized control messages and small data. Furthermore, such sets of buffers may be allocated and pre-registered for each connection established during startup. When many connections are established, the amount of memory consumed by the buffers may be quite substantial.

Accordingly, it may be advantageous to reduce the amount of memory consumed by the buffers in RDMA.

### BRIEF DESCRIPTION OF THE SEVERAL VIEWS OF THE DRAWINGS

The invention may best be understood by referring to the following description and accompanying drawings that are used to illustrate embodiments of the invention. In the drawings:

FIG. 1 is an exemplary block diagram illustrating Remote Direct Memory Access (RDMA), according to one or more embodiments of the invention.

FIG. 2 is an exemplary block flow diagram of a multi-stage buffer enlargement and RDMA data transfer method performed by sending and receiving nodes, according to one or more embodiments of the invention.

FIG. 3 is an exemplary block flow diagram of a multi-stage buffer enlargement and RDMA data transfer method that may be performed by a sending node, according to one or more other embodiments of the invention.

FIG. 4 is a block flow diagram of an exemplary method of provisioning large buffers for transmitting data by RDMA, according to one or more embodiments of the invention.

FIG. 5 is an exemplary block flow diagram of a method of determining whether small or large buffers are to be used to transfer data, according to one or more embodiments of the invention.

FIG. 6 is an exemplary block flow diagram of a buffer enlargement, initiation, and acknowledgement method that may be performed by a receiving node, according to one or more embodiments of the invention.

FIG. 7 is a block diagram showing a computer architecture suitable for implementing one or more embodiments of the invention.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description.

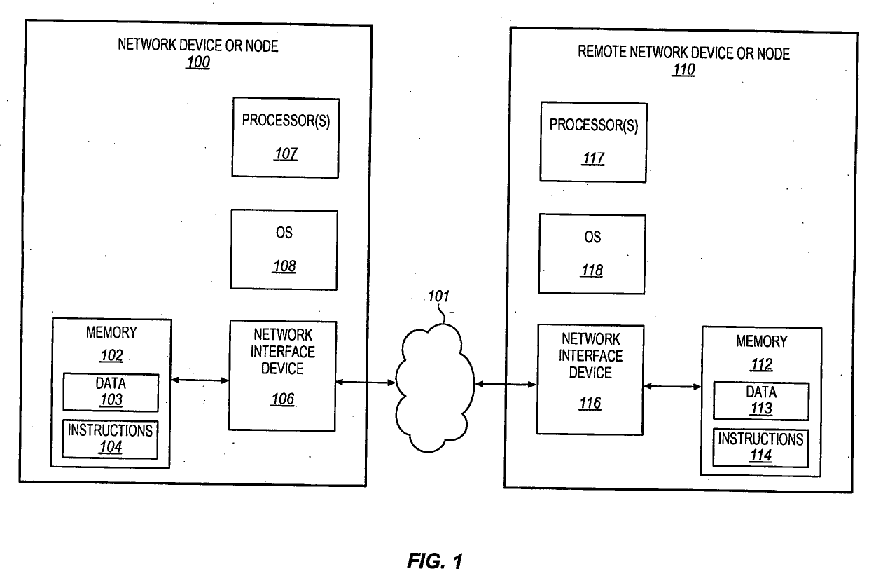

FIG. 1 is a block diagram illustrating Remote Direct Memory Access (RDMA), according to one or more embodiments of the invention. A first network device or node 100 exchanges data with a second network device or node 110 through a network 101. As used herein, unless specified otherwise, the terms network device or node may be used to refer to both the hardware and the software at a sending or receiving end of the data transfer or communication path. In one or more embodiments of the invention, the network devices are geographically separated from one another or remote.

Examples of suitable network devices include, but are not limited to, computer systems, such as, for example, personal computers and servers, storage devices, such as, for example hard disks, arrays of hard disks, optical disks, and other mass storage devices whether or not they are direct attached or fabric attached, and routers, such as, for example, storage routers. Examples of suitable networks include, but are not limited to, the Internet, intranets, storage networks, corporate networks, Ethernet networks, and the like, and combinations thereof. These are just a few illustrative examples, and the scope of the invention is not limited to just these examples.

Each of the network devices includes a memory to store data and instructions (for example software) and a network interface device to allow the network device to communicate over the network. In particular, the first network device includes a first memory 102 to store a first data 103 and a first set of instructions 104, and a first network interface device 106. Likewise, the second network device includes a second memory 112 to store a second data 113 and a second set of instructions 114, and a second network interface device 116.

Examples of suitable types of memory include, but are not limited to, read/write Random Access Memory (RAM), such as, for example, Dynamic Random Access Memory (DRAM) and Static RAM (SRAM), and other types of application memory known in the arts. Examples of suitable network interface devices include, but are not limited to, network interface cards (NICs), network adapters, network interface controllers, host bus adapters (HBAs), and other known hardware to allow the network device to communicate over the network whether it plugs into an expansion slot or integrated with the motherboard. These are just a few illustrative examples, and the scope of the invention is not limited to just these examples.

In addition, each of the network devices includes one or more processors 107, 117 to process information and an operating system (OS) 108, 118. In one or more embodiments of the invention, the processors may include processors, such as, for example, multi-core processors, available from Intel Corporation, of Santa Clara, Calif. Alternatively, other processors may optionally be used.

As previously stated, the first network device exchanges data with the second network device through the network. In one or more embodiments of the invention, the data is exchanged through RDMA.

In RDMA two or more potentially remote computers or other network devices may exchange data directly between their respective main memories without the data passing through the processors of either network device and without extensive involvement of the operating system of either network device. Data is transferred directly from the main application memory without the need to copy data to the buffers of the operating system.

As shown, data may be exchanged along a direct communication between the first and second memories through the first and second network interface devices and the network. The data that is exchanged does not need to flow through the processors or operating system of either of the network devices. This may offer advantages that are well known in the arts, such as, for example, reduced load on the processor.

In one or more embodiments of the invention, a multi-phase buffer enlargement procedure may be implemented in order to provision buffers for RDMA data transfer. Initially, a set of relatively small RDMA buffers sufficient for transferring many control messages and small user data may be provisioned for RDMA data transfer during startup. These buffers may be used to transfer many of the small control and user data messages commonly encountered. Then, subsequently, when messages are encountered that are too large to be accommodated by the already provisioned, small RDMA buffers, this may be determined and larger buffers may be accordingly be provisioned. This may help to reduce the total memory consumption due to the buffers and/or allow more connections to be established.

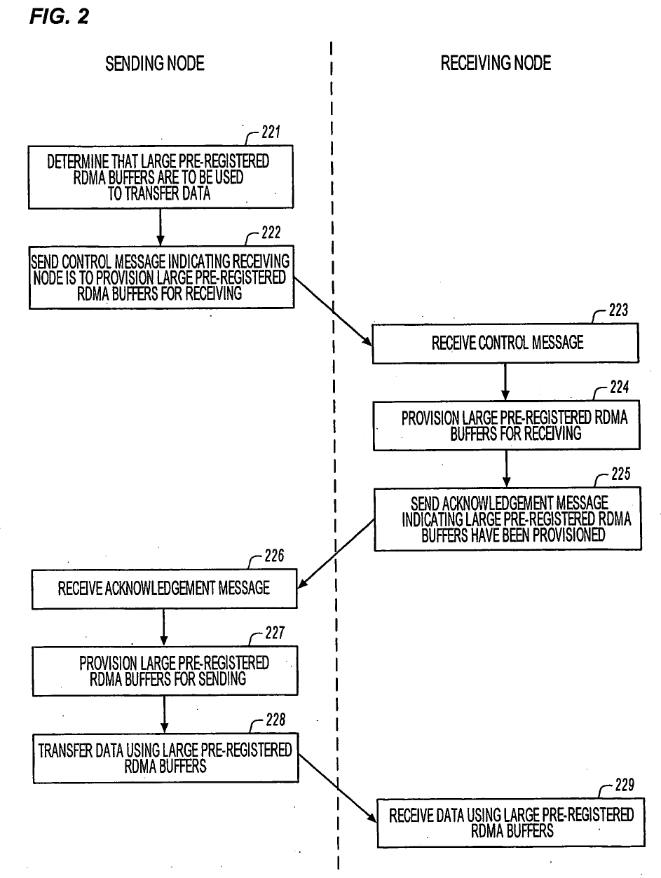

FIG. 2 is an exemplary block flow diagram of a multi-stage buffer enlargement and RDMA data transfer method performed by sending and receiving nodes, according to one or more embodiments of the invention. Operations that may be performed by the sending node are to the left of a central dashed line, whereas operations performed by a receiving node are to the right of the dashed line. In one or more embodiments of the invention, the method may be implemented by the sending and receiving nodes or network devices executing software, such as routines or other sets of instructions, which may be stored on machine-accessible and readable mediums such as hard drives and discs.

At block 221, the sending node may determine that large pre-registered RDMA send buffers are needed, or are otherwise to be used, to transfer data. In one or more embodiments of the invention, the sending node may determine that the data is too large to be accommodated by the already provisioned small buffers or at least with a desired tolerance. Then, at block 222, the sending node may send a control message indicating that the receiving node is to provision large pre-registered RDMA receiving buffers to receive data.

Processing may then transfer to the receiving node. At block 223, the receiving node may receive the control message. Then, at block 224, the receiving node may provision large pre-registered RDMA receive buffers to receive data. Next, at block 225, the receiving node may send an acknowledgement message to the sending node. The acknowledgement message may indicate that the large pre-registered RDMA receive buffers have been provisioned. The acknowledgement message may also include information to communicate with the newly provisioned large RDMA receive buffers, such as, for example, an address, and a remote key.

Processing may then transfer back to the sending node. At block 226, the sending node may receive the acknowledgement message. Then, at block 227, the sending node may provision large pre-registered RDMA send buffers to send data. Next, at block 228, the sending node may transfer data using the large pre-registered RDMA send buffers. In one or more embodiments of the invention, the sending device may copy data from a source, such as, for example, an application memory, to the large pre-registered RDMA send buffers, and then perform an RDMA data transfer from the large pre-registered RDMA send buffers to the large pre-registered RDMA receive buffers.

Processing may then return once again to the receiving node. At block 229, the receiving node may receive the data using the large pre-registered RDMA receive buffers. In one or more embodiments of the invention, the received data may be copied from the large pre-registered RDMA receive buffers to a destination, such as, for example, an application memory.

The small pre-registered RDMA buffers and the enlarged or large pre-registered RDMA buffers discussed herein may have different sizes. In one or more embodiments of the invention, the size of the small buffers may be only a small fraction of the size of the large buffers. For example, in one or more embodiments of the invention, the size of the small buffers may be an order of magnitude or more smaller than the size of the large buffers. In various embodiments of the invention, the small buffers may be large enough to accommodate a majority of the control messages commonly encountered, while the large buffers may be larger and large enough to accommodate the larger less commonly encountered large control messages, although the scope of the invention is not so limited.

It is difficult to place a precise circumference on the optimal sizes of the small and large buffers, since this may vary from one implementation to another and may depend on the hardware. Suitable sizes may be readily determined for a particular implementation without undue experimentation. By way of example, in one or more embodiments of the invention, the size of the small buffers may range from about 100 to 2,000 bytes, and the size of the large buffers may range from 1,000 to 200,000 bytes, although the scope of the invention is not so limited. As another example, in one or more embodiments of the invention, the size of the small buffers may range from about 200 to 1,000 bytes, and the size of the large buffers may range from about 2,000 to 50,000 bytes, although this is not required. In one particular embodiment, the size of the small buffers may range from about 500 to 800 bytes and the size of the large buffers may range from about 5,000 to 20,000 bytes, although this is not required. However, the scope of the invention is not limited to these particular size ranges. Buffers having other sizes are also suitable. In one or more embodiments of the invention, the sizes of the small and/or the large buffers may optionally be reconfigurable by the user so that the user may reconfigure the size of the threshold.

Advantageously, using such a multi-phase or stepwise buffer enlargement may help to reduce memory consumption and/or allow a larger number of processes or connections to be supported. By way of example, in one particular implementation, without using such a technique, about 256 KB of memory may be consumed by the buffers for each established connection, whereas only about 16 KB of memory may be consumed by the buffers for each established connection if the technique is used. This is just one example, and the scope of the invention is not limited to such an example or such a reduction in memory consumption.

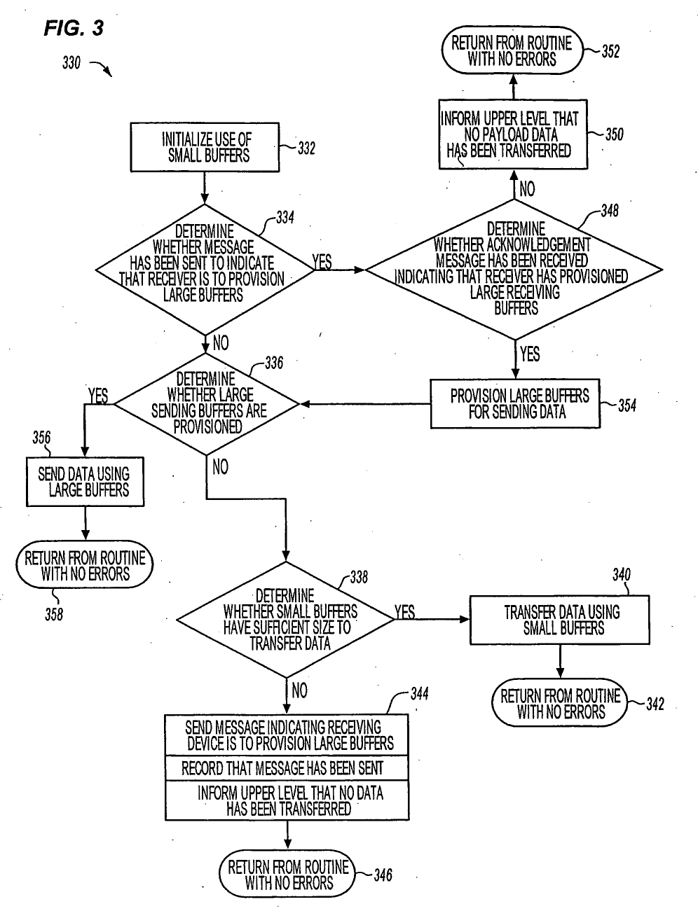

FIG. 3 is an exemplary block flow diagram of a multi-stage buffer enlargement and RDMA data transfer method that may be performed by a sending node, according to one or more embodiments of the invention. In this method, data may be transferred from a sending network device or node to a potentially potentially remote receiving network device or node.

In one aspect, the method may be performed by the sending network device invoking and executing a routine or other set of instructions, which may be stored on and accessed from a machine-readable medium. In one aspect, the routine may be invoked through an interface through which an upper level, such as, for example, a message passing interface (MPI) level, may exchange information used in the method. Non-limiting examples of types information that may be exchanged through the interface include, but are not limited to, virtual channel information, data transfer vector information, and data transfer status information. However, the scope of the invention is not limited to passing any known type of information. In one or more embodiments of the invention, the routine may be performed one or more times for each virtual channel used for communication between the sending and receiving devices, although this is not required.

Initially, as shown at block 332, the sending node may be initialized or configured to use small buffers. By way of example, in one or more embodiments of the invention, a variable may be set to a predetermined value, such as, for example, zero or some other integer. The small buffers may be used as long as the variable has this predetermined value. If the value of the variable is changed to a second predetermined value, such as, for example, 1, then large buffers may be used. However, the scope of the invention is not limited to just this particular approach. Other approaches for configuring the network device to use small or large buffers may also optionally be used.

The method may advance from block 332 to block 334. At block 334, a determination may be made whether a control message has already been sent to instruct or otherwise indicate that the receiver (receiving node or device) is to provision large buffers for receiving. By way of example, in one or more embodiments of the invention, this determination may involve determining whether a variable has a predetermined value, such as, for example, some integer, that corresponds to the condition that the message has been sent. If the variable equals the predetermined value, then the determination is that the message has been sent. Otherwise, the determination is that the message has not been sent. However, this particular approach is not required. Other approaches for recording that the control message has been sent are also suitable.

If the determination at block 334 is that the control message has not yet been sent (i.e., “no” is the determination), then the method may advance to block 336. This may be the case the first pass through the method and/or the first time the routine has been invoked to attempt to transfer a given data. At block 336, a determination may be made whether the large buffers have already been provisioned for transferring data.

If the determination at block 336 is that the large buffers have not yet been provisioned for transferring data (i.e., “no” is the determination), then only the small buffers may presently be available to transfer data, and the method may proceed to block 338. This may be the case the first pass through the method and/or the first time the routine has been invoked to attempt to transfer a given data, unless the use of small buffers is not initialized.

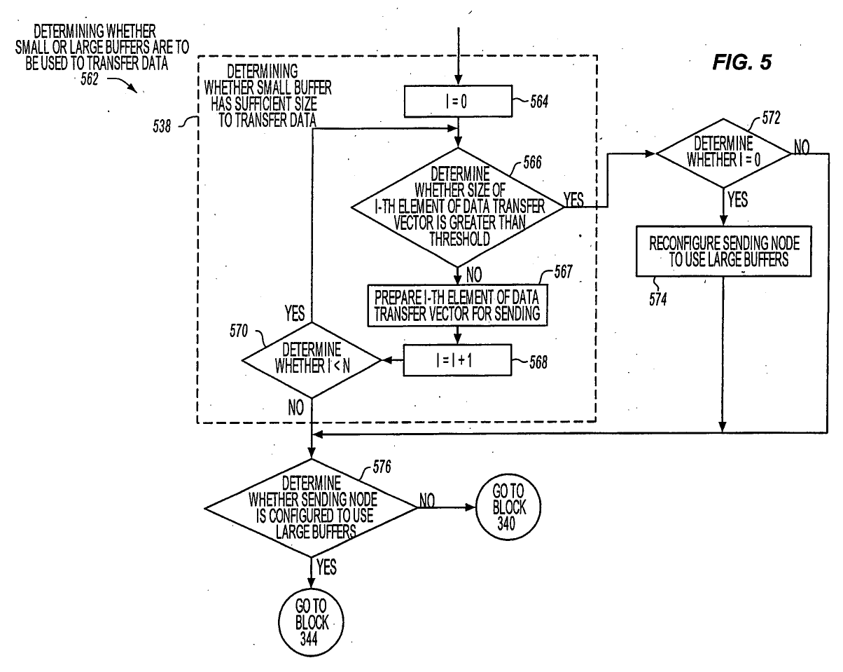

At block 338, the method may determine whether the small buffers have sufficient size to transfer the data. In one or more embodiments of the invention, this determination may involve examining the size of the data, such as, for example, comparing the size of the data to the size of the small buffers, or a predetermined threshold related to the size of the small buffers, in order to determine whether the data will fit in the small buffers or fit in the small buffers with a certain tolerance. FIG. 5 shows one exemplary method of making this determination, although the scope of the invention is not limited to just this particular method.

If the determination at block 338 is that the small buffers have sufficient size to transfer the data (i.e., “yes” is the determination), then the method may advance to block 340. At block 340, the data may be transferred to the receiving device using the small buffers, without using large buffers. In one or more embodiments of the invention, the data may optionally be transferred according to one or more of a so-called and well-known “eager” protocol and/or a so-called and well-known “rendezvous” protocol, although this is not required. The method may then advance to block 342 where the routine may return with no errors, and the method may end.

Alternatively, if the determination at block 338 is that the small buffers do not have sufficient size to transfer the data (i.e., “no” is the determination), then the method may advance to block 344. At block 344, several operations may optionally be performed in various different orders.

One operation that may be performed is that the sending node may send a control message to the receiving node indicating that the receiving node is to provision and use large buffers to receive data on a given virtual channel. The control message may be sent instead of the actual payload/application data from the data transfer vector. The small buffers may be used to transfer the control message.

Another operation that may be performed is that the sending device may record or inform a relevant entity that the control message has been sent. By way of example, in one or more embodiments of the invention, a variable, such as, for example, the same variable discussed above for block 334, may be set to a predetermined value, such as, for example, an integer, which corresponds to the control message having been sent. However, this particular approach is not required. Other approaches for recording that the control message has been sent are also suitable. Note that recording that the control message has been sent may allow a subsequent determination at block 334 to be “yes”. In such a case, the acknowledgement message may be awaited before the data is transferred using the large buffers.

Yet another option that may be performed is that the sending device may inform an upper level, such as, for example, a message passing interface (MPI) level, that no payload/application data has been transferred. By way of example, in one or more embodiments of the invention, a variable may be set to a first predetermined value, such as, for example zero to indicate that zero payload/application data has been transferred, instead of one or more other predetermined values that would indicate that some payload/application data has actually been transferred. This status may optionally be passed to the upper level through the interface of the routine. The method may then advance to block 346, where the routine may return with no errors, and the method may end.

Now, in one or more embodiments of the invention, another instance of the routine may subsequently be invoked and executed to continue to attempt to transfer the data. Alternatively, in one or more embodiments of the invention, rather than returning from the routine and ending the method, the routine may loop back to the beginning. In order to avoid obscuring the description, the discussion below will tend to emphasize different or additional processing that may be performed during the subsequent execution of the routine or method.

At some point, the method may again advance to determination block 334. If the control message has already been sent to indicate that the receiver is to provision large buffers for a given virtual channel as a result of a previous execution of the routine or method, such as, for example, at block 344, then “yes” may be the determination at block 334 and the method may advance from block 334 to block 348.

At block 348, a determination may be made whether an acknowledgement message has been received instructing or indicating that the receiver or receiving node has provisioned large buffers for receiving data. By way of example, in one or more embodiments of the invention, the acknowledgment message may have multiple fields. The acknowledgement message may start with a head flag and end with a tail flag. Local variables corresponding to the head flag and the tail flag in the sending network device may initially be set to predetermined values indicating that the acknowledgement message has not yet been received. Then, the receiving network device may generate and send an acknowledgement message after or as part of the process of allocating large buffers. The acknowledgement message may specify different predetermined values to change the local variables corresponding to the head flag and the tail flag in the sending network device. The sending network device may poll or otherwise access the local variables corresponding to the head and tail flags. When the local variables corresponding to the head and tail flags have been changed to the different predetermined values specified in the acknowledgement message, the sending network device may determine that the acknowledgement message has been fully received. If the local variable corresponding to the head flag has been changed, but the local variable corresponding to the tail flag has not been changed, then the sending network device may enter a loop or otherwise wait, and re-poll the local variable corresponding to the tail flag, until it is changed to the predetermined value indicating the full acknowledgment message has been received. However, the scope of the invention is not limited to this particular approach. Other approaches for recording and determining whether acknowledgement messages have been received may alternatively optionally be used.

If the determination at block 348 is that the acknowledgement message has not been received (i.e., “no” is the determination), then the method may advance to block 350. By way of example, in one or more embodiments of the invention, this may occur due to a lack of receipt of a head flag, or this may occur due to elapse of a predetermined amount of time after receiving the head flag without receiving the tail flag. As another example, the acknowledge message may be in error or corrupt. In other words, a complete error-free acknowledgment message may not have been received within a predetermined amount of time.

At block 350, the routine may inform an upper level, such as, for example, an MPI level, that no data, such as, for example, payload or application data of interest, has been transferred. The sending node may elect not to transfer data, since the receiving node may potentially be unready to receive it on large buffers, and may inform other relevant entities that no data has been transferred. In one or more embodiments of the invention, the upper level may be informed through status passed through an interface of the routine, although this is not required. The method may then advance to block 352, where the routine may return with no errors, and the method may end.

Alternatively, if the determination at block 348 is that the acknowledgement message has been received (i.e., “yes” is the determination), then the method may advance to block 354. At block 354, the sending node may provision large buffers for transmitting data.

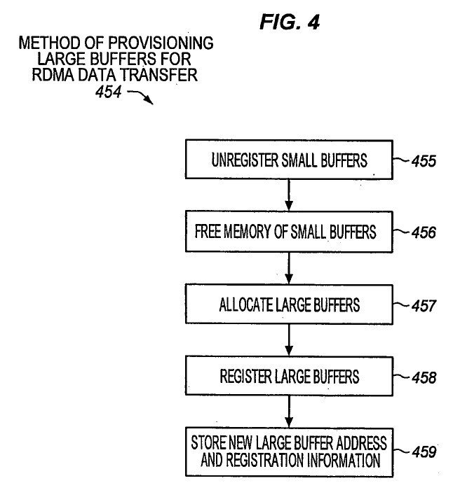

FIG. 4 is a block flow diagram of an exemplary method 454 of provisioning large buffers for transmitting data by RDMA, according to one or more embodiments of the invention. The method assumes that the memory for the small buffers is to be freed and reused for the large buffers, although this is not required.

At block 455, the small buffers may be unregistered, such as, for example, in an RDMA capable low level application programming interface (API) like direct access protocol layer (DAPL). Next, at block 456, the memory for the small buffers may be freed or made available to the system. This is not required but may help to reduce total memory consumption. At block 457, the large buffers may be allocated, such as, for example, by the C-runtime function malloc( ), or another memory management function or system call. At block 458, the large buffers may be registered by the RDMA capable low level API. At block 459, the new large buffer address and registration information may be stored. For example, a remote key identifying the large receiving buffers on the receiving device may be stored locally so that it may be subsequently used for data transfer. The remote key may be included in the acknowledgement message that indicates that the receiving network device has provisioned large receiving buffers. Alternatively, the storage of the remote key may be performed at other times in the method. Information to provision the large buffers for receiving may also optionally be communicated to the remote network device, if desired. Then, a control variable of the sending network device may be set to allow data to be transferred from the sending device to the receiving device (not shown). This latter operation is not necessarily part of provisioning. By way of example, in one or more embodiments of the invention, the control variable may be set to a predetermined value, such as, for example, an integer.

Referring again to FIG. 3, after provisioning the large buffers at block 354, the method may advance to the previously described block 336. At block 336, a determination may be made whether the large buffers have been provisioned for sending data. This time, as a result of provisioning the large buffers at block 354, the determination at block 336 may be “yes” instead of “no”. In such a case, the method may advance from block 336 to block 356. At block 356, the data may be sent or transferred using the large buffers. In one or more embodiments of the invention, this may include copying the data into the large sending buffers and then performing an RDMA transfer of the data from the large sending buffers to the potentially remote large receiving buffers. In one or more embodiments of the invention, either a so-called eager or a so-called rendezvous protocol may optionally be used, although this is not required. The method may then advance to block 358 where the routine may return with no errors, and the method may end.

Now, particular methods have been described above in detail in order to illustrate certain concepts. However, the scope of the invention is not limited to these particular methods. Many variations of the methods are contemplated, and will be apparent to those skilled in the art and having the benefit of the present disclosure. For example, alternate embodiments are contemplated in which the operations of the methods are performed in different order from that described. By way of example, in various alternate embodiments of the invention, the large buffers may be provisioned before the control message is sent and/or before the acknowledgement message is received. Further, alternate embodiments are contemplated in which operations are added to and/or removed from the methods. By way of example, rather than two phases, three or more phases of provisioning RDMA buffers of different progressively increasing sizes, may optionally be performed. These are just a few illustrative modifications. Many further modifications and adaptations may be made to the methods and are contemplated.

FIG. 5 is an exemplary block flow diagram of a method 562 of determining whether small or large buffers are to be used to transfer data, according to one or more embodiments of the invention.

A dashed block 538 is shown around blocks 564-570. The dashed block 538 represents one example of a determination whether the small buffers have sufficient size to transfer the data.

Initially, at block 564, a look counter (i) may be initialized to a starting value. In the illustrated embodiment, the starting value is zero, although this is not required. The starting value may alternatively be one or some other starting value. The data may be provided in the form of a data transfer vector. The data transfer vector may have a predetermined integer number of elements, starting with the starting element and ending with an ending element n, where n may represent the predetermined integer number of the last element in the data transfer vector. The value of the loop counter may uniquely index or select a single element of the data transfer vector.

The method may advance from block 564 to block 566. At block 566, a determination may be made whether a size of the current (i-th) element of the data transfer vector is greater than a predetermined threshold. In one or more embodiments of the invention, the predetermined threshold may be related to a size of the already allocated and registered small buffers. If the size of the current element is compared to and found to be greater than the predetermined threshold, then the current element may not fit in the small buffer or may not fit in the small buffer with a desired tolerance or margin. In such a case, buffer enlargement may be appropriate.

As with the optimal size of the small buffers, it tends to be difficult to place a precise circumference on the optimal size of the predetermined threshold, since this may tend to vary from one implementation to another. By way of example, in various embodiments of the invention, the predetermined threshold may be equal to the size of the small buffers or may be some percentage, such as, for example, 80 to 99%, of the small buffers. For example, in various embodiments of the invention, the predetermined threshold may be between about 100 to 2000 bytes, between 200 to 1000 bytes, between 300 to 800 bytes, or between about 400 to 700 bytes. These ranges may be sufficient for some implementations but are not required. If desired, other ranges may be readily determined by those skilled in the art for a particular implementation without undue experimentation. Furthermore, in one or more embodiments of the invention, routine may optionally allow the size of the predetermined threshold to be reconfigurable.

If the determination at block 566 is that the size of the current (i-th) element of the data transfer vector is not greater than the predetermined threshold (i.e., “no” is the determination), then the method may advance to block 567. At block 567, the i-th element of the data transfer vector may be prepared for sending.

The method may advance from block 567 to block 568. At block 568, the loop counter may be incremented by one or otherwise increased. This may select the next element of the data transfer vector for processing.

The method may advance from block 568 to block 570. At block 570, a determination may be made whether the current value of the loop counter (i) is less than the predetermined integer n, where n may represent the last element in the data transfer vector. If i<n (i.e., “yes” is the determination), then the method may revisit block 566. Otherwise, if “no” is the determination, the method may advance from block 570 to block 576. The method may loop or iterate through blocks 566, 568, and block 570 one or more times until exiting through either block 572 or block 576.

Now, the scope of the invention is not limited to the particular illustrated approach for determining whether the small buffers have sufficient size to transfer the data. Other approaches are also contemplated and will be apparent to those skilled in the art and having the benefit of the present disclosure. By way of example, in one or more alternate embodiments, the largest of the data may be identified, such as, for example, by sorting or internal comparison, and only the largest of the data may be compared with the threshold. In this way, all of the elements need not be compared to the threshold. Additionally, it is not required to use a threshold. Other approaches such as passing the data through a size filter, looking at metadata that describes the data, or other approaches may optionally be used. Another approach is to similarly use a loop but start with the highest element and decrement the loop counter. Yet another approach may include summarizing all lengths of data vector elements greater than threshold. Still other alternate methods of making the determination are contemplated and will be apparent to those skilled in the art and having the benefit of the present disclosure.

Referring again to determination block 566, if for one of the elements of the data transfer vector, the determination is that the size of the current element is greater than the predetermined threshold (i.e., “yes” is the determination), then the method may advance to block 572. At block 572, a determination may be made whether the current value of the loop counter is equal to the starting value of the data transfer vector. In other words, a determination may be made whether the current element being processed is the first element of the data transfer vector. For example, in the illustrated embodiment, a determination may be made whether i=0. Alternatively, other starting values, such as, for example, one, may be appropriate for other implementations.

If the determination at block 572 is that the current value of the loop counter is equal to the starting value of the data transfer vector (i.e., “yes” is the determination), then the method may advance to block 574. At block 574, the sending node may be configured to use large buffers for transferring data. By way of example, in one or more embodiments of the invention, the variable that was previously initialized at block 332 in FIG. 3, may be set or changed from the initial value, such as, for example, zero, to a different predetermined value, such as, for example, one. This may configure the sending node to use large buffers for transferring data. The large buffers may not yet be provisioned, but the state of the sending node may be changed to indicate that enlarged buffers are to be used. The method may then advance to block 576.

Alternatively, if the determination at block 572 is that the current value of the loop counter is not equal to the starting value of the data transfer vector (i.e., “no” is the determination), then the method may advance directly to block 576 without configuring the network device to use large buffers. That is, the method may exit the loop despite the fact that the loop counter may be less than n.

In such a case, a starting portion or subset, but not all, of the data transfer vector, which includes elements all sized less than the predetermined threshold, may be transferred to the receiving node. Then, the remaining or ending portion of the data transfer vector may be transferred in another execution of the routine or method. The first element of the ending portion of the data transfer vector may be the first element previously determined to be larger than the threshold.

It is to be appreciated, however, that this feature of the method is optional, and not required. Alternate embodiments are contemplated in which the entire data transfer vector may be transferred using the large buffers if any element of the data transfer vector is greater than the threshold.

At block 576, a determination may be made whether the sending device is configured to use large buffers. Recall that initially the sending device may have been initialized or configured to use small buffers, such as, for example, at block 332 of FIG. 3, and potentially reconfigured to use large buffers, such as, for example, at block 574.

If the sending node is not configured to use large buffers (i.e., “no” is the determination), then the data may be transferred using the small buffers, such as, for example, by advancing to block 340 of FIG. 3. Alternatively, if the sending node is configured to use large buffers (i.e., “yes” is the determination), then the method may send a control message to the receiver indicating that the receiver is to provision large buffers for receiving, such as, for example, at block 344 of FIG. 3.

As discussed above, after receiving an acknowledgement message from the receiver, such as, for example, as shown at block 348, and after provisioning the large buffers for the sending node, such as, for example, as shown at block 354, the data may ultimately be sent using the large buffers, such as, for example, as shown at block 356.

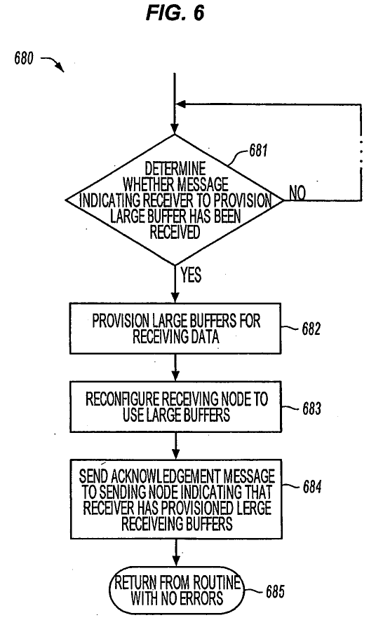

FIG. 6 is an exemplary block flow diagram of a buffer enlargement, initiation, and acknowledgement method 680 that may be performed by a receiving node, according to one or more embodiments of the invention. In one or more embodiments of the invention, the method may be performed by a routine or other set of instructions executed on the receiving node. The receiver may also perform other conventional operations which are not discussed to avoid obscuring the description.

At block 681, a determination may be made whether the control message indicating that the receiver is to provision large buffers for receiving has been received. If the control message has been received (i.e., “yes” is the determination), then the method may advance to block 682. Otherwise, the method may loop back to or revisit block 681. The ellipsis indicates that execution is not blocked until “yes” is the determination, but rather the receiving node may proceed with processing using the small buffers and when appropriate revisit block 681.

At block 682, the large buffers for receiving data may be provisioned. In one or more embodiments of the invention, this may include unregistering the existing small buffers, such as, for example, from an RDMA capable low level application programming interface (API) like direct access protocol layer (DAPL), and freeing the memory of the small buffers to the system. This is not required but may help to reduce total memory consumption. Next, in one or more embodiments of the invention, the larger receiving buffers may then be allocated and registered, such as, for example, with DAPL or another RDMA capable API.

The method may then advance to block 683. At block 683, the receiving node may be reconfigured to use large buffers. By way of example, in one or more embodiments of the invention, a variable may be set or changed from an initial value, to a different predetermined value. Other approaches are also contemplated and are suitable.

The method may then advance to block 684. At block 684, an acknowledgement message may be sent to the sending node indicating that the receiver has provisioned the large receiving buffers. The acknowledgement message may previously be generated by including the addresses of the newly provisioned larger buffers, and the remote key after registration. The head and tail flags of the acknowledgement message may also be generated. The method may then advance to block 685, where the routine may return without errors, and the method may end.

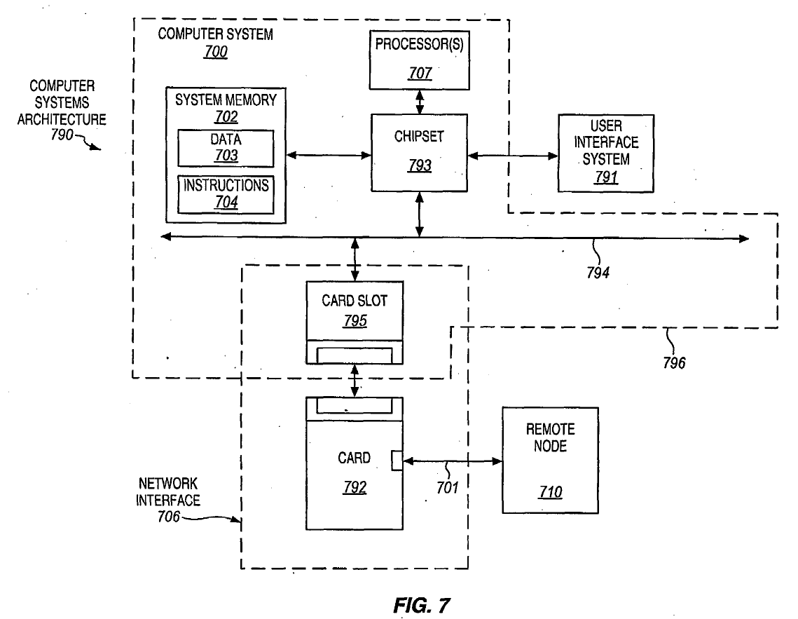

FIG. 7 is a block diagram showing a computer architecture 790 including a computer system 700, a user interface system 791, a remote node 710, and a card 792 to allow the computer system to interface with the remote node through a network 701, according to one or more embodiments of the invention. As used herein, a “computer system” may include an apparatus having hardware and/or software to process data. The computer system may include, but is not limited to, a portable, laptop, desktop, server, or mainframe computer, to name just a few examples. The computer system represents one possible computer system for implementing one or more embodiments of the invention, however other computer systems and variations of the computer system are also possible. Other electronic devices besides computer systems are also suitable.

The computer system includes a chipset 793. In one or more embodiments of the invention, the chipset may include one or more integrated circuits or other microelectronic devices, such as, for example, those that are commercially available from Intel Corporation. However, other microelectronic devices may also, or alternatively, be used.

The computer system includes one or more processor(s) 707 coupled with or otherwise in communication with the chipset to process information. In one or more embodiments, the processor(s) may include those of the Pentium® family of processors, such as, for example, a Pentium® 4 processor, which are commercially available from Intel Corporation, of Santa Clara, Calif. Alternatively, other processors may optionally be used. As one example, a processor having multiple processing cores may be used, although this is not required.

The computer system includes a system memory 702 coupled with or otherwise in communication with the chipset. The system memory may store data 703, such as, for example, data to be exchanged with the remote node by RDMA, and instructions 704, such as, for example, to perform methods as disclosed herein.

In one or more embodiments of the invention, the system memory may include a main memory, such as, for example, a random access memory (RAM) or other dynamic storage device, to store information including instructions to be executed by the processor. Different types of RAM memory that are included in some, but not all computer systems, include, but are not limited to, static-RAM (SRAM) and dynamic-RAM (DRAM). Other types of RAM that are not necessarily dynamic or need to be refreshed may also optionally be used. Additionally, in one or more embodiments of the invention, the system memory may include a read only memory (ROM) to store static information and instructions for the processor, such as, for example, the basic input-output system (BIOS). Different types of memory that are included in some, but not all, computer systems include Flash memory, programmable ROM (PROM), erasable-and-programmable ROM (EPROM), and electrically-erasable-and-programmable ROM (EEPROM).

A user interface system 791 is also coupled with, or otherwise in communication with, the chipset. The user interface system may representatively include devices, such as, for example, a display device, a keyboard, a cursor control device, and combinations thereof, although the scope of the invention is not limited in this respect. For example, some computer systems, such as servers, may optionally employ simplified user interface systems.

One or more input/output (I/O) buses or other interconnects 794, are each coupled with, or otherwise in communication with the chipset. As shown in the illustrated embodiment, a network interface 706 may be coupled with the one or more I/O interconnects. The illustrated network interface includes a card slot 795 and the card 792. The card may include logic to allow the computer system and the remote node to communicate, such as, for example, by RDMA.

Now, as shown in the illustrated embodiment, the processor(s), system memory, chipset, one or more I/O interconnects, and card slot may optionally be included on or otherwise connected to a single circuit board 796, such as, for example, a motherboard or backplane. The motherboard and the components connected thereto are often housed within a chassis or primary housing of the computer system. The slot may represent an opening into the chassis or housing into which the card may be inserted.

However, this particular configuration is not required. Numerous alternate computer system architecture embodiments are also contemplated. For example, in various alternate embodiments of the invention, the network interface 706 may be either entirely internal or external to the chassis or housing of the computer system. As another example, in one or more alternate embodiments of the invention, logic similar to that described above for the card may also or alternatively be included in the chipset. Many additional modifications are also contemplated.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact or be in communication with each other.

In the description above, for the purposes of explanation, numerous specific details have been set forth in order to provide a thorough understanding of the embodiments of the invention. One or more other embodiments may be practiced without some of these specific details. The particular embodiments described are not provided to limit the invention but to illustrate it. The scope of the invention is not to be determined by the specific examples provided above but only by the claims below. In other instances, well-known circuits, structures, devices, and operations have been shown in block diagram form or without detail in order to avoid obscuring the understanding of the description.

Modifications may be made to the embodiments disclosed herein. All equivalent relationships to those illustrated in the drawings and described in the specification are encompassed within embodiments of the invention.

Various operations and methods have been described. Some of the methods have been described in a basic form, but operations may optionally be added to and/or removed from the methods. The operations of the methods may also often optionally be performed in different order. Many modifications and adaptations may be made to the methods and are contemplated.

Certain operations may be performed by hardware components, or may be embodied in machine-executable instructions, that may be used to cause, or at least result in, a circuit programmed with the instructions performing the operations. The circuit may include a general-purpose or special-purpose processor, or logic circuit, to name just a few examples. The operations may also optionally be performed by a combination of hardware and software.

One or more embodiments of the invention may be provided as a program product or other article of manufacture that may include a machine-accessible and/or readable medium having stored thereon one or more instructions and/or data structures. The medium may provide instructions, which, if executed by a machine, may result in and/or cause the machine to perform one or more of the operations or methods disclosed herein. Suitable machines include, but are not limited to, computer systems, network devices, network interface devices, communication cards, host bus adapters, and a wide variety of other devices with one or more processors, to name just a few examples.

The medium may include, a mechanism that provides, for example stores and/or transmits, information in a form that is accessible by the machine. For example, the medium may optionally include recordable and/or non-recordable mediums, such as, for example, floppy diskette, optical storage medium, optical disk, CD-ROM, magnetic disk, magneto-optical disk, read only memory (ROM), programmable ROM (PROM), erasable-and-programmable ROM (EPROM), electrically-erasable-and-programmable ROM (EEPROM), random access memory (RAM), static-RAM (SRAM), dynamic-RAM (DRAM), random access memory whether or not it needs to be refreshed, Flash memory, and combinations thereof.

For clarity, in the claims, any element that does not explicitly state “means for” performing a specified function, or “step for” performing a specified function, is not to be interpreted as a “means” or “step” clause as specified in 35 U.S.C. Section 112, Paragraph 6. In particular, any potential use of “step of” in the claims herein is not intended to invoke the provisions of 35 U.S.C. Section 112, Paragraph 6.

It should also be appreciated that reference throughout this specification to “one embodiment”, “an embodiment”, or “one or more embodiments”, for example, means that a particular feature may be included in the practice of the invention. Similarly, it should be appreciated that in the description various features are sometimes grouped together in a single embodiment, Figure, or description thereof for the purpose of streamlining the disclosure and aiding in the understanding of various inventive aspects. This method of disclosure, however, is not to be interpreted as reflecting an intention that the invention requires more features than are expressly recited in each claim. Rather, as the following claims reflect, inventive aspects may lie in less than all features of a single disclosed embodiment. Thus, the claims following the Detailed Description are hereby expressly incorporated into this Detailed Description, with each claim standing on its own as a separate embodiment of the invention.

Accordingly, while the invention has been thoroughly described in terms of several embodiments, those skilled in the art will recognize that the invention is not limited to the particular embodiments described, but may be practiced with modification and alteration within the spirit and scope of the appended claims. The description is thus to be regarded as illustrative instead of limiting.

What is claimed is:

1. A method comprising:
determining that a pre-registered remote direct memory access (RDMA) buffer has insufficient size to transfer data;
provisioning a larger RDMA buffer; and
transferring the data to a network using the larger RDMA buffer.

2. The method of claim 1, further comprising:
sending a control message indicating that a receiver is to provision a larger RDMA buffer to receive the data; and
prior to said transferring, receiving an acknowledgement message indicating that the receiver has provisioned the larger RDMA buffer.

3. The method of claim 1, wherein said determining comprises comparing a size of the data to a predetermined threshold.

4. The method of claim 3, further comprising comparing sizes of a plurality of elements of an input-output vector to the predetermined threshold.

5. The method of claim 1, wherein said provisioning comprises allocating and registering the larger RDMA buffer during a communication phase.

6. The method of claim 1, wherein said provisioning comprises:
unregistering the pre-registered RDMA buffer; and
freeing the memory used by the pre-registered RDMA buffer.

7. The method of claim 1, wherein said transferring comprises:
copying data from a source to the larger RDMA buffer; and
performing an RDMA transfer from the larger RDMA buffer to the network.

8. An article of manufacture comprising:
a machine-accessible medium that provides instructions that if executed result in a machine performing operations including,
determining that a size of data to be transferred by remote direct memory access (RDMA) is larger than a predetermined threshold; and
allocating and registering an RDMA buffer having a size larger than the predetermined threshold during a communication phase of an RDMA data transfer.

9. The article of manufacture of claim 8, wherein the machine-accessible medium further provides instructions that if executed result in the machine performing operations comprising:
sending a message indicating that a receiver is to provision an RDMA buffer having a size larger than the predetermined threshold; and
receiving an acknowledgement message indicating that the receiver has provisioned the larger RDMA buffer.

10. The article of manufacture of claim 8, wherein the machine-accessible medium further provides instructions that if executed result in the machine performing operations including comprising:
copying data from a source to the RDMA buffer; and
performing an RDMA transfer from the RDMA buffer to a receiving node.

11. A system comprising:
an interconnect;
one or more processors coupled with the interconnect;
a dynamic random access memory (DRAM) coupled with the interconnect to store data;
a network interface device coupled with the interconnect to transfer data to a network by using an Ethernet protocol;
machine-readable instructions stored in the DRAM that if executed result in a machine performing operations comprising:
determining that a pre-registered remote direct memory access (RDMA) buffer is too small to transfer data;
provisioning an RDMA buffer having a size larger than the pre-registered RDMA buffer; and
transferring the data to a network using the provisioned RDMA buffer.

12. The method of claim 11, further comprising:
sending a message indicating that a receiver is to provision an RDMA buffer having a size larger than the pre-registered RDMA buffer to receive the data; and
prior to said transferring, receiving an acknowledgement message indicating that the receiver has provisioned the RDMA receive buffer.

13. The method of claim 1, wherein said determining comprises comparing a size of the data to a predetermined threshold, wherein said provisioning comprises allocating and registering the larger RDMA send buffer during a communication phase, and wherein said transferring comprises copying data from a source to the larger RDMA send buffer.

14. The method of claim 11, wherein the pre-registered RDMA buffer has a size ranging from 100 to 2,000 bytes, and wherein the provisioned RDMA buffer has a size ranging from 1,000 to 200,000 bytes.

15. A method comprising:
receiving a control message indicating to provision an remote direct memory access (RDMA) buffer having a size larger than a pre-registered RDMA buffer;
provisioning the RDMA buffer;
receiving data into the provisioned RDMA buffer.

16. The method of claim 15, further comprising sending an acknowledgement message indicating that the RDMA buffer has been provisioned.

17. The method of claim 15, wherein said provisioning comprises allocating and registering the RDMA buffer during a communication phase.

18. The method of claim 15, wherein said provisioning comprises:
unregistering the pre-registered RDMA buffer; and
freeing the memory used by the pre-registered RDMA buffer.

19. The method of claim 15, further comprising copying the data from the provisioned RDMA buffer to a destination.

20. The method of claim 15, implemented in a network device comprising:
a bus;
a dynamic random access memory coupled with the bus to store data; and
a processor having multiple cores.
